(19) United States
(12) Patent Application Publication
(10) Pub. No.: US 2014/0270260 A1
(43) Pub. Date: Sep. 18, 2014

(54) SPEECH DETECTION USING LOW POWER MICROELECTRICAL MECHANICAL SYSTEMS SENSOR

(71) Applicants: Michael Goertz, Redwood City, CA (US); Thomas Alan Donaldson, Nailsworth (GB)

(72) Inventors: Michael Goertz, Redwood City, CA (US); Thomas Alan Donaldson, Nailsworth (GB)

(73) Assignee: AliphCom, San Francisco, CA (US)

(21) Appl. No.: 14/203,467

(22) Filed: Mar. 10, 2014

Related U.S. Application Data
(60) Provisional application No. 61/780,896, filed on Mar. 13, 2013.

(51) Int. Cl. G06F 3/16; H04R 1/00; G10L 15/20; H04R 23/00; G10L 15/22; G10L 15/28

(52) U.S. Cl. CPC G06F 3/167; G10L 15/22; G10L 15/28; G10L 15/20; H04R 23/006; H04R 1/00; H04R 2201/003
USPC 381/110

(57) ABSTRACT

Devices and techniques for speech detection using low power microelectrical mechanical systems (MEMS) sensor are described, including monitoring acoustic energy using a microelectrical mechanical system sensor, detecting a presence of speech using a voice activity detection device comprising a voice activity detection logic and the microelectrical mechanical system sensor formed on die, switching a host system from a first power mode to a second power mode, using a power manager, upon receiving a signal from the voice activity detection device indicating a presence of speech, the host system comprising one or more sensors and a speech recognition module configured to recognize a speech command, and taking an action in response to the speech command.

### CROSS-REFERENCE TO RELATED APPLICATIONS

This application claims the benefit of U.S. Provisional Patent Application No. 61/780,896 (Attorney Docket No. ALI-143P), filed Mar. 13, 2013, which is incorporated by reference herein in its entirety for all purposes.

### FIELD

The present invention relates generally to electrical and electronic hardware and speech detection. More specifically, techniques for speech detection using a low power microelectrical mechanical system (MEMS) sensor are described.

### BACKGROUND

Conventional devices and techniques for speech detection typically require multiple separate components, such as a voice activity detection device, a microphone array or other acoustic sensor, a signal processor, and other computing devices for processing acoustic signals and noise cancellation. Implementing each of these components on separate circuits, and then connecting them as a system for speech detection using conventional techniques, is inefficient and uses a lot of power. Although microelectrical mechanical systems (MEMS) microphones exist to combine microphones with certain limited processing capabilities, they are not well-suited for speech detection and recognition.

Also, conventional techniques for separating speech from background noise using microphone arrays typically do not perform well in noisy environments. Other conventional techniques for separating speech from noise require a sensor touching the face to correlate with speech. However, such sensors can be uncomfortable, and unreliable if they do not maintain constant contact with the face, or if there is a barrier between the sensor and skin.

Thus, what is needed is a solution for speech detection using a low power MEMS sensor without the limitations of conventional techniques.

### BRIEF DESCRIPTION OF THE DRAWINGS

Various embodiments or examples (“examples”) are disclosed in the following detailed description and the accompanying drawings:

FIG. 1 illustrates a block diagram of an exemplary speech detection system;

FIG. 2 illustrates a block diagram of another exemplary speech detection system;

FIG. 3 illustrates a flow for detecting speech;

FIG. 4 illustrates a block diagram of an alternative exemplary speech detection system; and

FIG. 5 illustrates a flow for separating speech from noise.

Although the above-described drawings depict various examples of the invention, the invention is not limited by the depicted examples. It is to be understood that, in the drawings, like reference numerals designate like structural elements. Also, it is understood that the drawings are not necessarily to scale.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (“application”) or as a plug-in, module, or sub-component of another application. The described techniques may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including ASP, ASP.net, .Net framework, Ruby, Ruby on Rails, C, Objective C, C++, C#, Adobe® Integrated Runtime™ (Adobe® AIR™), ActionScript™, Flex™, Lingo™, Java™, Javascript™, Ajax, Perl, COBOL, Fortran, ADA, XML, MXML, HTML, DHTML, XHTML, HTTP, XMPP, PHP, and others. Design, publishing, and other types of applications such as Dreamweaver®, Shockwave®, Flash®, Drupal and Fireworks® may also be used to implement the described techniques. Database management systems (i.e., “DBMS”), search facilities and platforms, web crawlers (i.e., computer programs that automatically or semi-automatically visit, index, archive or copy content from, various websites (hereafter referred to as “crawlers”)), and other features may be implemented using various types of proprietary or open source technologies, including MySQL, Oracle (from Oracle of Redwood Shores, Calif.), Solr and Nutch from The Apache Software Foundation of Forest Hill, Md., among others and without limitation. The described techniques may be varied and are not limited to the examples or descriptions provided.

FIG. 1A illustrates a block diagram of an exemplary speech detection system. Here, diagram 100 includes low power voice activity detection (VAD) device 102 (including bus 104, microelectrical mechanical system (MEMS) sensor 106, analog-to-digital converter (ADC) 108, digital signal processor (DSP) 110, and VAD logic 112), power source 114, and host system 116 (including bus 118, signal processing module 120, speech recognition module 122, power manager 124 and sensor 126). In some examples, MEMS sensor 106 may be a MEMS microphone, accelerometer, or other acoustic or vibration sensor. In some examples, one or more of MEMS sensor 106, ADC 108, DSP 110 and VAD logic 112 may be integrated on die (i.e., on the same integrated circuit or silicon chip (e.g., microchip)), for example, using complementary metal-oxide-semiconductor (CMOS) MEMS processing techniques (e.g., technology by Akustica Inc., of Pittsburgh, Pa., for building acoustic transducers and accelerometers). For example, ADC 108 may be implemented as part of (i.e., built into or integrated with) MEMS sensor 106. In another example, VAD logic 112 may be implemented as part of DSP 110. In some examples, low power VAD device 102 may be configured to continuously or periodically monitor acoustic or vibrational energy (e.g., MEMS sensor 106 may be configured to sample acoustic or vibrational energy continuously or at very short intervals (i.e., quick rate), MEMS sensor 106 may provide a continuous stream of data associated with the acoustic or vibrational energy being sampled to VAD logic 112, and/or MEMS sensor 106 may provide period data associated with the acoustic or vibrational energy being sampled at a quick rate, or the like). In other examples, low power VAD device 102 may sample acoustic or vibrational energy periodically (e.g., MEMS sensor 106 may be configured to sample acoustic or vibrational energy frequently, or at a specified rate, and/or MEMS sensor 106 may provide periodic data associated with the acoustic or vibrational energy being sampled to VAD logic 112, or the like).

In some examples, VAD logic 112 may be configured to detect a trigger (i.e., an event) that indicates a presence of speech to be captured and processed (i.e., using speech recognition module 122). In some examples, the trigger may be a spike (i.e., sudden increase) in acoustic energy (e.g., acoustic vibrations, signals, pressure waves, and the like), a speech characteristic, a predetermined (i.e., pre-programmed) word, a loud noise (e.g., a siren, an automobile crash, a scream, or other noise), or the like. When VAD logic 112 detects such a trigger, VAD logic 112 may provide a signal to host system 116 to switch (i.e., wake) from a low (or off) power mode to a high (or on) power mode. For example, VAD logic 112 may be implemented as a peak energy tracking system configured to detect, using data from MEMS sensor 106, a peak, spike, or other sudden increase in acoustic or vibrational energy, and to send a signal indicating a presence of speech to power manager 124 upon detection of said energy spike. In another example, VAD logic 112 may be configured to sense the presence of speech by detecting speech characteristics (e.g., articulation, pronunciation, pitch, rate, rhythm, and the like), and to send a signal indicating a presence of speech to power manager 124 upon detection of one or more of said speech characteristics. For example, speech patterns associated with said characteristics may be pre-programmed into VAD logic 112. In still another example, VAD logic 112 may be configured to detect a trigger word, which may be pre-programmed into VAD logic 112 such that VAD logic 112 may send a signal indicating a presence of speech to power manager 124 upon detection of said trigger word. In yet another example, VAD logic 112 may be configured to detect (i.e., using an accelerometer (e.g., MEMS sensor 106)) a tap (e.g., physical strike, light hit, brief touch, or the like), for example, on a housing (not shown) in which low power VAD device 102 may be housed, encased, mounted, or otherwise installed. VAD logic 112 may be configured to send a signal indicating a presence of speech to power manager 124 upon detection of said tap. In some examples, triggers may be programmed using an interface (e.g., control interface 228 in FIG. 2) implemented as part of host system 116.

In some examples, power source 114 may be implemented as a battery, battery module, or other power storage. As a battery, power source 114 may be implemented using various types of battery technologies, including Lithium Ion (“LI”), Nickel Metal Hydride (“NiMH”), or others, without limitation. In some examples, power may be gathered from local power sources such as solar panels, thermo-electric generators, and kinetic energy generators, among other power sources. These additional sources can either power the system directly or can charge power source 114, which, in turn, may be used to power the speech detection system. Power source 114 also may include circuitry, hardware, or software that may be used in connection with, or in lieu of, a processor in order to provide power management (e.g., power manager 124), charge/recharging, sleep, or other functions. Power drawn as electrical current may be distributed from power source 114 via bus 104 and/or bus 118, which may be implemented as deposited or formed circuitry or using other forms of circuits. Electrical current distributed from power source 114, for example, using bus 104 and/or bus 118, may be managed by a processor (not shown) and may be used by one or more of the components (shown or not shown) of low power VAD device 102 and host system 116.

In some examples, power manager 124 may be configured to provide control signals to other components of host system to power on (i.e., high power or full capture mode) or off (i.e., low power mode) in response to a signal from low power VAD device indicating whether or not there is speech (i.e., a presence of speech). For example, when low power VAD device 102 detects a presence of speech, low power VAD device 102 may provide a signal (i.e., using VAD logic 112 and a communication interface (not shown)) to power manager 124 to switch host system 116 from a low power mode, wherein host system 116 draws a minimal amount of power (i.e., sufficient power to operate power manager 124 to receive a signal from low power VAD device 102) to a high power mode, wherein host system 116 draws more power from power source 114 (i.e., sufficient power to operate signal processing module 120, speech recognition module 122, sensor 126, and other components of host system 116). In another example, once low power VAD device 102 detects a change from a presence of speech to an absence of speech, low power VAD device 102 may provide another signal indicating an absence of speech to power manager 124 to switch host system 116 from a high power mode back to a low power mode. In still other examples, low power VAD device also may be configured to detect a speech (i.e., verbal) command to manually switch host system 116 to an off or low power mode. For example, VAD logic 112, or another module of low power VAD device 102 or host system 116, may be pre-programmed to detect a verbal command (e.g., “off,” “low power,” or the like), and to send the another signal to power manager 124 causing power manager 124 to switch host system 116 from a high power mode back to a low power mode (i.e., by sending control signals to various components of host system 116). In some examples, power manager 124 may be configured to send control signals associated with other modes, in addition to high and low power modes, to other components of host system 116 (e.g., signal processing module 120, speech recognition module 122, sensor 126, or the like) or other components (e.g., power source 114, VAD logic 112, or the like). For example, power manager 124 may be configured to send a control signal to an individual component to turn it on (i.e., wake it up).

In some examples, speech recognition module 122 may be configured to process data associated with speech signals, for example, detected by sensor 126 or MEMS sensor 106. For example, speech recognition module 122 may be configured to recognize speech, such as speech commands. In some examples, host system 116 may include signal processing module 120, which may be configured to supplement or off-load (i.e., from digital signal processor 110) signal processing capabilities when host system 116 is operating in a high power or full capture mode. In some examples, signal processing module 120 may be configured to have hardware signal processing capabilities.

In some examples, sensor 126 may operate as an acoustic sensor. In other examples, sensor 126 may operate as a vibration sensor. In some examples, sensor 126 may be implemented using multiple silicon microphones. In another example, sensor 126 may be implemented using multiple accelerometer modules. In still other examples, the above-described elements may be implemented differently in layout, design, function, structure, features, or other aspects and are not limited to the examples shown and described.

FIG. 2 illustrates a block diagram of another exemplary speech detection system. Here, diagram 200 includes host system 216, which includes low power VAD device 202 (including integrated MEMS sensor and ADC 206 and integrated DSP and VAD logic 210), bus 204, power source 214, control interface 218, signal processing module 220, speech recognition module 222, power manager 224, and sensor 226. Like-numbered and named elements may describe the same or substantially similar elements as those shown in other descriptions. In some examples, low power VAD device 202 may be implemented as part of host system 216 on die with one or more of other components of host system 216. In some examples, low power VAD device 202 may be configured to detect a presence or absence of speech, as described herein. In some examples, low power VAD device 202 may send signals indicating such presence or absence of speech to power manager 224, for example, using bus 204. In some examples, in response to such signals from low power VAD device, power manager 224 may send control signals to one, some or all of the other remaining components of host system 216 (e.g., signal processing module 220, speech recognition module 22, sensor 226, and the like), to turn the components on or off, or otherwise cause them to begin, increase, or stop drawing power from power source 214. In some examples, control interface 218 may be implemented as part of host system 216. In other examples, control interface 218 may be implemented separately or independently of host system 216 (e.g., using a mobile computing device, a mobile communications device, or the like). In some examples, control interface 218 may be used to configure host system 216. In still other examples, the above-described elements may be implemented differently in layout, design, function, structure, features, or other aspects and are not limited to the examples shown and described.

FIG. 3 illustrates a flow for detecting speech. Here, flow 300 begins with monitoring a signal from a MEMS sensor (302). In some examples, a MEMS sensor may be used to capture or sample acoustic energy in the environment, and to generate sensor data associated with said acoustic energy. In some examples, a signal from a MEMS sensor may be monitored using a VAD device (e.g., low power VAD devices 102 and 202 in FIGS. 1 and 2, respectively). In some examples, a VAD device may be integrated with a host device configured to process and recognize speech (see FIG. 2). In some examples, a MEMS sensor may be configured to sample acoustic or vibrational energy continuously. In other examples, a MEMS sensor may be configured to sample acoustic or vibrational energy periodically. In some examples, a MEMS sensor may be configured to provide continuous data associated with a continuous sampling of acoustic or vibrational energy to a VAD logic module (e.g., VAD logic 112 in FIG. 1 or integrated DSP and VAD logic 210 in FIG. 2). In other examples, MEMS sensor may be configured to provide data associated with periodic sampling of acoustic or vibrational energy to a VAD logic module.

As a signal from a MEMS sensor is being monitored, a VAD device (e.g., low power VAD devices 102 and 202 in FIGS. 1 and 2, respectively), including a VAD logic (e.g., VAD logic 112 in FIG. 1 or integrated DSP and VAD logic 210 in FIG. 2) and the MEMS sensor, both formed on die, may be used to detect a presence of speech (304). Once a presence of speech is detected by the VAD sensor, a host system may be switched from a first power mode to a second power mode, the host system including one or more sensors and a speech recognition module configured to recognize the speech (306). In some examples, the first power mode may be a lower power mode (i.e., a sleep state), during which components of the host system necessary to detect the presence of speech are on (i.e., awake and drawing power), and the remaining components of the host system are off (i.e., asleep and not drawing power). In some examples, the second power mode may be a high power mode (i.e., awake or full capture state), during which many or all of the components of the host system are on and using power.

As used herein, recognizing speech includes processing speech to identify, categorize, verify, store or otherwise derive meaning, from data associated with speech. Once the speech is being processed, an action associated with the speech may be taken (308). For example, the speech may include one or more commands, and a host system may be configured to take one or more actions in response to each of the one or more commands. For example, a speech recognition module may be configured to identify speech commands and to initiate actions associated with said speech commands (e.g., to turn on in response to an “on” command, to turn off in response to an “off” command, to switch modes in response to an associated command, to send control signals to other modules or devices in response to other associated commands, and the like). In another example, a speech recognition module may be configured to identify and store speech patterns (i.e., for one or more users). In yet another example, a speech recognition module may be configured to match sensor data (e.g., from MEMS sensor 106 and/or sensor 126 in FIG. 1, integrated MEMS sensor and ADC 206 and sensor 226 in FIG. 2, or the like) with stored, or otherwise accessible, speech patterns, or other data associated with such speech patterns. In other examples, the above-described process may be varied in steps, order, function, processes, or other aspects, and is not limited to those shown and described.

FIG. 4 illustrates a block diagram of an alternative exemplary speech detection system. Here, diagram 400 includes host system 402, which includes bus 404, microphone array 406, accelerometer 408, VAD 410, speech recognition module 412, DSP 414 and power source 416. Like-numbered and named elements may describe the same or substantially similar elements as those shown in other descriptions. In some examples, host system 402 may be implemented on or with a wearable device (not shown). For example, host system 402 may be implemented in a headset (i.e., wired or wireless headset) configured to be worn on a user's head or on an ear. In some examples, microphone array 406 may include two or more microphones. In some examples, microphone array 406 may be implemented with directional microphones, and configured to be more sensitive to acoustic sound from a predetermined direction. In some examples, accelerometer 408 may be configured to detect movement associated with host system 402. For example, host system 402 may be implemented in a headset worn on a user's head or ear, and accelerometer 408 may be configured to detect movement caused by a turning or nodding of said user's head. In some examples, DSP 414 may be configured to process acoustic data from microphone array 406 and to correlate the acoustic data with sensor data from accelerometer 408, the sensor data indicating a movement of host system 402 (i.e., movement of a head). In some examples, DSP 414 may be configured to determine which part of the acoustic data correlates well with the movement of host system 402 using the sensor data, and also determine which other part of the acoustic data that correlates poorly with the movement of host system 402. For example, when sensor data indicates a movement (i.e., change in direction) of host system 402, DSP 414 may be configured to expect a corresponding change in acoustic data. In this example, DSP 414 may be configured to determine that said other part of acoustic data that does not change correspondingly (i.e., correlates poorly) with said movement corresponds to speech (i.e., a user's mouth does not change position relative to said user's head, and thus corresponding acoustic data will be received by microphone array 406 from the same direction despite head movement). In some examples, DSP 414 may be configured to attenuate the part of the acoustic data that correlates well with (i.e., changes corresponding to) a movement of host system 402, and to strengthen said other part of acoustic data corresponding to speech. In other examples, the above-described elements may be implemented differently in layout, design, function, structure, features, or other aspects and are not limited to the examples shown and described.

FIG. 5 illustrates a flow for separating speech from noise. Here, flow 500 begins with receiving, using a wearable device, acoustic signal from a microphone array (502). In some examples, a wearable device also may capture sensor data associated with movement of the wearable device using an accelerometer (504). In some examples, movement of a wearable device may correspond to movement of a user, or part of a user (i.e., head). Then, the acoustic signal may be correlated with the sensor data, for example using a digital signal processor (e.g., DSP 110 and signal processing module 120 in FIG. 1, DSP/HSP 220 and DSP+VAD logic 210 in FIG. 2, DSP 414 in FIG. 4, or the like), to determine a part of the acoustic signal that correlates well with the movement and another part of the acoustic signal that correlates poorly with the movement (506). In some examples, acoustic signal may include both speech and noise, the speech originating from a user that is wearing a wearable device, for example, on said user's head. As a user moves its head, a position of the wearable device, and an accelerometer implemented in said wearable device, remains the same with respect to said user's mouth (i.e., a source of speech), but noise from surroundings will change. Thus, movement by a user will correspond, or correlate well, with changes in noise. On the other hand, there will be little to no corresponding changes (e.g., magnitude, direction, and other acoustic parameters) associated with the part of the acoustic input associated with speech. Thus, the part of the acoustic signal corresponding to speech will be poorly correlated with the changes reflected in movement of a wearable device being worn on a head. The part of the acoustic signal that correlates well with the movement (i.e., corresponding to noise) may then be separated from the other part of the acoustic signal that correlates poorly with the movement (i.e., corresponding to speech) (508). Then the part of the acoustic signal that correlates well with movement may be attenuated or dampened (510); and the other part of the acoustic signal that correlates poorly with movement, said other part being associated with speech, may be strengthened (512). In other examples, the above-described process may be varied in steps, order, function, processes, or other aspects, and is not limited to those shown and described.

The structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit.

According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method, comprising:
monitoring acoustic energy using a microelectrical mechanical system sensor;
detecting a presence of speech using a voice activity detection device comprising a voice activity detection logic and the microelectrical mechanical system sensor formed on die;
switching a host system from a first power mode to a second power mode, using a power manager, upon receiving a signal from the voice activity detection device indicating a presence of speech, the host system comprising one or more sensors and a speech recognition module configured to recognize a speech command; and
taking an action in response to the speech command.

2. The method of claim 1, wherein the detecting the presence of speech comprises detecting a peak in the acoustic energy using sensor data from the microelectrical mechanical system sensor.

3. The method of claim 1, wherein the detecting the presence of speech comprises detecting a speech characteristic.

4. The method of claim 1, wherein the detecting the presence of speech comprises detecting a trigger word.

5. The method of claim 1, wherein the detecting the presence of speech comprises detecting a tap.

6. The method of claim 1, wherein the detecting the presence of speech comprises detecting a loud sound.

7. The method of claim 1, wherein the microelectrical mechanical system sensor comprises a microphone.

8. The method of claim 1, wherein the microelectrical mechanical system sensor comprises an acoustic sensor.

9. The method of claim 1, wherein the microelectrical mechanical system sensor comprises a vibration sensor.

10. The method of claim 1, wherein the microelectrical mechanical system sensor comprises an accelerometer.

11. The method of claim 1, wherein the monitoring the acoustic energy comprises monitoring sensor data generated by the microelectrical mechanical system sensor in response to the acoustic energy captured using the microelectrical mechanical system sensor.

12. The method of claim 1, wherein the monitoring the acoustic energy comprises continuously monitoring the acoustic energy in an environment.

13. The method of claim 1, wherein the monitoring the acoustic energy comprises periodically sampling the acoustic energy in an environment.

14. The method of claim 1, further comprising switching the host system from the second power mode to the first power mode, using the power manager, in response to another signal from the voice activity detection device indicating an absence of speech.

15. The method of claim 1, further comprising switching the host system from the second power mode to the first power mode, using the power manager, in response to another speech command.

16. The method of claim 1, wherein switching the host system from the first power mode to the second power mode comprises switching the host system from a low power mode to a high power mode.

17. The method of claim 1, wherein the voice activity detection device is configured to draw sufficient power to operate the voice activity detection logic and the microelectrical mechanical system sensor when the host system is operating in the first power mode.

18. The method of claim 1, wherein the host system is configured to draw sufficient power to operate the one or more sensors, the speech recognition module, and a signal processing module when the host system is operating in the second power mode.
